(19) United States
(12) Patent Application Publication
(10) Pub. No.: US 2018/0082030 A1
(43) Pub. Date: Mar. 22, 2018

(54) Automatic Adjustment of Treatment Recommendations Based on Economic Status of Patients

(71) Applicant: International Business Machines Corporation, Armonk, NY (US)

(72) Inventors: Corville O. Allen, Morrisville, NC (US); Timothy A. Bishop, Minneapolis, MN (US)

(21) Appl. No.: 15/268,965

(22) Filed: Sep. 19, 2016

(51) Int. Cl. G06F 19/00; G06F 17/30

(52) U.S. Cl. CPC G06F 19/325; G06F 19/363; G06F 19/345; G06F 17/3053; G06F 19/322; G06F 19/3456; G06F 19/328

(57) ABSTRACT

Mechanisms are provided that ingest medical treatment information data structure for a medical payment provider. The medical treatment information data structure provides treatment information including costs to patients for one or more medical treatments. The mechanisms generate a set of insight data structures based on the ingested medical treatment information for the at least one medical payment provider. The mechanisms process personal information about a patient to determine an economic status of the patient and process an electronic medical record for the patient identifying a medical condition of the patient. The mechanisms select a medical treatment based on the set of insight data structures and the economic status of the patient and output a recommendation for treating the patient.

### BACKGROUND

The present application relates generally to an improved data processing apparatus and method and more specifically to mechanisms for providing automatic adjustment of treatment recommendations based on economic status of patients.

Decision-support systems exist in many different industries where human experts require assistance in retrieving and analyzing information. An example that will be used throughout this application is a diagnosis system employed in the healthcare industry. Diagnosis systems can be classified into systems that use structured knowledge, systems that use unstructured knowledge, and systems that use clinical decision formulas, rules, trees, or algorithms. The earliest diagnosis systems used structured knowledge or classical, manually constructed knowledge bases. The Internist-I system developed in the 1970s uses disease-finding relations and disease-disease relations. The MYCIN system for diagnosing infectious diseases, also developed in the 1970s, uses structured knowledge in the form of production rules, stating that if certain facts are true, then one can conclude certain other facts with a given certainty factor. DXplain, developed starting in the 1980s, uses structured knowledge similar to that of Internist-I, but adds a hierarchical lexicon of findings.

Iliad, developed starting in the 1990s, adds more sophisticated probabilistic reasoning where each disease has an associated a priori probability of the disease (in the population for which Iliad was designed), and a list of findings along with the fraction of patients with the disease who have the finding (sensitivity), and the fraction of patients without the disease who have the finding (1-specificity).

In 2000, diagnosis systems using unstructured knowledge started to appear. These systems use some structuring of knowledge such as, for example, entities such as findings and disorders being tagged in documents to facilitate retrieval. ISABEL, for example, uses Autonomy information retrieval software and a database of medical textbooks to retrieve appropriate diagnoses given input findings. Autonomy Auminence uses the Autonomy technology to retrieve diagnoses given findings and organizes the diagnoses by body system. First CONSULT allows one to search a large collection of medical books, journals, and guidelines by chief complaints and age group to arrive at possible diagnoses. PEPID DDX is a diagnosis generator based on PEPID's independent clinical content.

Clinical decision rules have been developed for a number of medical disorders, and computer systems have been developed to help practitioners and patients apply these rules. The Acute Cardiac Ischemia Time-Insensitive Predictive Instrument (ACI-TIPI) takes clinical and ECG features as input and produces probability of acute cardiac ischemia as output to assist with triage of patients with chest pain or other symptoms suggestive of acute cardiac ischemia. ACI-TIPI is incorporated into many commercial heart monitors/defibrillators. The CaseWalker system uses a four-item questionnaire to diagnose major depressive disorder. The PKC Advisor provides guidance on 98 patient problems such as abdominal pain and vomiting.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, the at least one memory comprising instructions executed by the at least one processor to cause the at least one processor to implement a cognitive medical treatment recommendation system. The method comprises ingesting, by the cognitive medical treatment recommendation system, medical treatment information data structure for a medical payment provider. The medical treatment information data structure provides treatment information including costs to patients for one or more medical treatments. The method further comprises generating, by the cognitive medical treatment recommendation system, a set of insight data structures based on the ingested medical treatment information for the at least one medical payment provider, and processing, by the cognitive medical treatment recommendation system, personal information about a patient to determine an economic status of the patient. Moreover, the method comprises processing, by the cognitive medical treatment recommendation system, an electronic medical record for the patient identifying a medical condition of the patient to generate a plurality of candidate treatment options for treating the medical condition of the patient. In addition, the method comprises selecting, by the cognitive medical treatment recommendation system, a treatment option from the plurality of candidate treatment options based on the set of insight data structures and the economic status of the patient. Furthermore, the method comprises outputting, by the cognitive medical treatment system, the selected treatment option for use in treating the medical condition of the patient.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a cognitive healthcare system in a computer network;

FIG. 2 is a block diagram of an example data processing system in which aspects of the illustrative embodiments are implemented;

FIG. 3 is an example diagram illustrating an interaction of elements of a healthcare cognitive system in accordance with one illustrative embodiment;

FIG. 4 illustrates a cognitive healthcare system implementing a Question and Answer (QA) or request processing pipeline for processing an input question or request in accordance with one illustrative embodiment; and

FIG. 5 is a flowchart outlining an example operation of a healthcare cognitive system with regard to a treatment recommendation operation that evaluates the affordability of treatments for a patient in accordance with one illustrative embodiment.

### DETAILED DESCRIPTION

The strengths of current medical diagnosis, patient health management, and patient treatment recommendation systems are that they can improve medical practitioners' diagnostic hypotheses, can help medical practitioners avoid missing important diagnoses, and can assist medical practitioners with determining appropriate treatments for specific diseases. However, current systems still suffer from significant drawbacks which should be addressed in order to make such systems more accurate and usable for a variety of healthcare applications as well as more representative of the way in which human healthcare practitioners diagnose and treat patients. In particular, one drawback of current systems is that treatment recommendations do not necessarily take into consideration the patient's ability to pay for the treatment being recommended and thus, treatment recommendation systems may generate treatment recommendations that simply are not helpful to the healthcare practitioner as the patient will not be able to agree to the recommended treatment due to economic considerations.

For example, medical insurance companies establish and utilize guidelines indicating the types of treatments that the insurance company recommends and will pay for, the amount they will pay, the amount the patient must pay, etc., for patients having certain medical conditions. As part of these insurance guidelines, there are insurance formularies which list the medications that the insurance company will pay for, how much they will pay, what the patient's copay amount will be, etc. These formularies are generally organized by tiers with tier 1 medications generally being more expensive than tier 2, and so on. However, treatment recommendation systems do not generally take into consideration the patient's ability to pay for the medications of the various tiers when determining what medications should be prescribed to the patient for their particular medical condition. Treatment recommendation systems may take into consideration interaction of medications, particular side effects of such medications, and the like, but do not consider the patient's economic status, and hence their ability to pay for the treatments being recommended.

Cognitive medical treatment recommendation systems utilize various corpora to generate insights, represented as in-memory data structures, which are used to process patient electronic medical record (EMR) data. For example, one type of documentation used in the corpora includes the insurance company guidelines discussed above, or other payer guidelines indicating the medical treatments for which the payer agrees to pay, the conditions under which the medical treatment will be paid, and the amounts that the payer will pay, as well as any amounts for which the patient is responsible. This information may be used along with other medical treatment guideline information, if any, to generate the in-memory data structures used by the cognitive medical treatment recommendation system. For example, if a treatment recommendation guideline states that “For female patients 40 or older, diagnosed with Type 2 Diabetes, the patient should be given a prescription of Drug Z unless they have a history of hypertension”, then a corresponding insight data structure may be of the type “gender=female, age>=40, diagnosis=Type 2 Diabetes, history=not hypertension, treatment=Drug Z”. This insight data structure may be further correlated to in-memory payer guideline insight data structures and/or augmented to include such information extracted from payer guideline information.

As an example, using pharmaceuticals as an example treatment, a core concept of the illustrative embodiments is the concept to utilize the formularies, or other representations of medical treatments, associated with the insurance company guidelines of the particular insurance company, or other payer employed by the particular patient, as well as a cognitive analysis of the patient's economic status, to adjust the treatment recommendations for the patient to recommend treatments that fall within a tier of the formulary that matches the patient's economic status. That is, the treatment recommendation system recommends medications in a tier of the formulary that the patient is likely to be able to afford based on an analysis of their economic status. This will reduce the likelihood that a doctor will prescribe an expensive medication to a patient that simply cannot afford it without considering less costly alternatives to the expensive medication.

It should be appreciated that the consideration of cost to the patient may be subordinate to the effectiveness of the medication for treating the patient's medical condition and other factors that would affect providing the best possible treatment for the patient's condition, i.e. a less effective medication may not be prioritized over a more effective medication without approval by the medical professional treating the patient. In some embodiments, a balance of effectiveness, negative effects, and the like, relative to cost is automatically performed so as to rank candidate treatments according to those that the patient can afford and which provide the best effectiveness with the least amount of negative effects (e.g., side effects and/or drug interactions). Thus, cost of the treatment relative to the patient's economic status is but one additional factor considered by the treatment recommendation system when evaluating candidate treatments for the patient's medical condition. However, in all cases, final treatment recommendation is always left to the medical profession and the treatment recommendation system of the illustrative embodiments is essentially a tool that may be used by the medical professional to assist them in determining which treatments are available and preferred for the particular patient and their medical condition.

The illustrative embodiments will be described in the context of the treatment recommendation being performed with regard to the prescribing of medications. However, it should be appreciated that the mechanisms of the illustrative embodiments may be implemented with regard to any treatment recommendation where pricing information may be ingested by a cognitive medical treatment recommendation system and used as a basis for recommending treatments for a patient to a healthcare professional. Thus, the illustrative embodiments may be used with various medical procedures (e.g., particular tests to be performed, outpatient care procedures performed in an office), surgeries and other more invasive medical procedures performed at a medical facility, medical equipment being prescribed for the patient (e.g., CPAP machines, implants, assisted living equipment, etc.), or the like. In some implementations, the mechanisms of the illustrative embodiments may be performed with regard to dental procedures, surgeries, equipment, and medications. In other implementations, the mechanisms of the illustrative embodiments may be performed with regard to optical procedures, surgeries, equipment, and medications. Essentially, any treatment recommendation system for treating a patient with regard to any medical condition that the patient may have, may implement the mechanisms of the illustrative embodiments without departing from the spirit and scope of the present invention.

With the illustrative embodiments, as part of the ingestion operation of the cognitive medical treatment recommendation system (hereafter the “treatment recommendation system”), the treatment recommendation system ingests insurance company guideline information indicating the formulary or formularies used by the insurance company, pharmaceutical company pricing information, government healthcare organization pricing and formulary information, or any other pricing information from payers of healthcare costs. For purposes of ease of description, it will be assumed that an insurance company's formulary information is ingested as part of the ingestion operation. This formulary information lists medications, the amounts paid by the insurance company and patient for this medication, the class of medication, medical conditions addressed by the medication, and the like. The ingestion of this information creates insight data structures that may then be applied to patient electronic medical record (EMR) data to recommend treatments to patients.

In recommending treatments to patients, in addition to other operations performed by the treatment recommendation system to recommend treatments, e.g., identifying the medical condition of the particular patient, determining a treatment based on treatment guidelines, the patient's comorbidities, contraindications, personal history, and the like, the illustrative embodiments further evaluate the patient's economic status to determine the affordability of the candidate treatments for the particular patient. The evaluation of the economic status may take into account various factors including income, geographical location of the patient (e.g., cost of living in different geographical locations is drastically different), previous medications prescribed and filled by the patient, marital status, number of dependents, and any other factors indicative of economic status of the patient or the ability of the patient to afford the candidate treatments.

Based on these factors, a picture of the economic status is generated and a rating of economic status is generated that corresponds to formulary tiers. The recommended treatments are then analyzed according to the determined economic status of the patient to select one or more treatments having medications in one or more tiers that correspond to the economic status of the patient. The corresponding recommended treatments then have their scores weighted accordingly within the cognitive medical treatment recommendation system to rank more highly the treatments that are most suited to the patient's particular needs, their effectiveness in treating the patient's medical condition with minimal side effects, and which the patient can afford based on their economic status.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

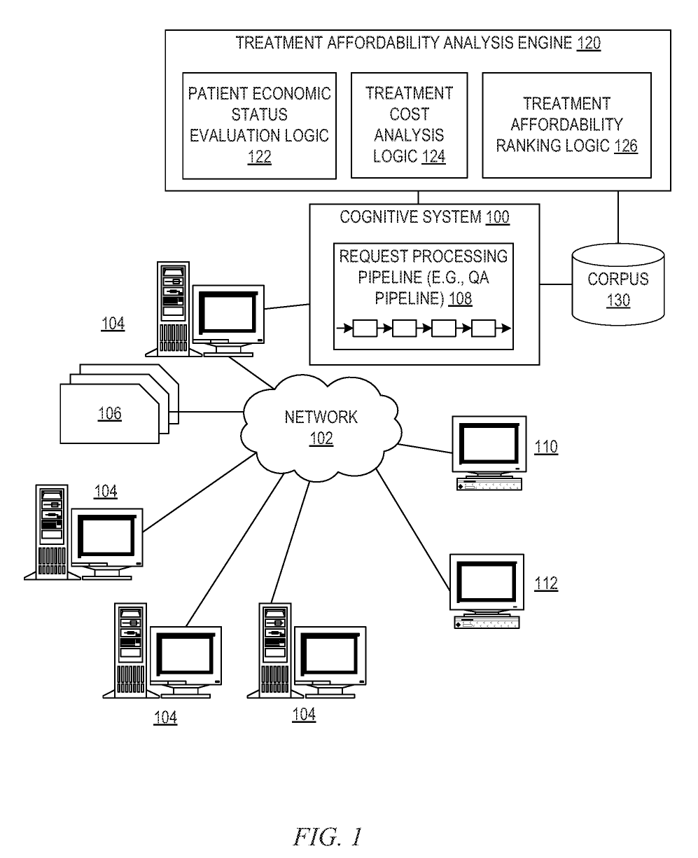

As noted above, the present invention provides mechanisms for generating treatment recommendations for patients that not only take into consideration the efficacy of a treatment for treating a patient's medical condition, but also takes into account the patient's personal ability to afford the treatment. These sometimes competing considerations are balanced and evaluated to generate a ranked listing of treatment recommendations for the patient's medical condition which may then be presented to the healthcare professional treating the patient to assist that healthcare professional in making a final determination as to what treatment to prescribe to the patient. The illustrative embodiments are employed in a cognitive system that is specifically configured to perform treatment recommendation operations for recommending treatments to healthcare practitioners for treating their patients. The cognitive system may be implemented in a variety of different types of data processing environments. In order to provide a context for the description of the specific elements and functionality of the illustrative embodiments, FIGS. 1-4 are provided hereafter as example environments in which aspects of the illustrative embodiments may be implemented. It should be appreciated that FIGS. 1-4 are only examples and are not intended to assert or imply any limitation with regard to the environments in which aspects or embodiments of the present invention may be implemented. Many modifications to the depicted environments may be made without departing from the spirit and scope of the present invention.

FIGS. 1-4 are directed to describing an example cognitive system for healthcare applications (also referred to herein as a “healthcare cognitive system”) which implements a request processing pipeline, such as a Question Answering (QA) pipeline (also referred to as a Question/Answer pipeline or Question and Answer pipeline) for example, request processing methodology, and request processing computer program product with which the mechanisms of the illustrative embodiments are implemented. These requests may be provided as structure or unstructured request messages, natural language questions, or any other suitable format for requesting an operation to be performed by the healthcare cognitive system. As described in more detail hereafter, the particular healthcare application that is implemented in the cognitive system of the present invention is a healthcare application for treatment recommendation generation using cognitive system abilities to analyze patient electronic medical records (EMRs) and one or more corpora of medical domain based information, evaluate the results of such analysis to generate treatment recommendations for treating one or more medical conditions of a patient, and then provide a ranked output of treatment recommendations to a healthcare professional to assist that healthcare professional in treating the patient.

It should be appreciated that the healthcare cognitive system, while shown as having a single request processing pipeline in the examples hereafter, may in fact have multiple request processing pipelines. Each request processing pipeline may be separately trained and/or configured to process requests associated with different domains or be configured to perform the same or different analysis on input requests (or questions in implementations using a QA pipeline), depending on the desired implementation. For example, in some cases, a first request processing pipeline may be trained to operate on input requests directed to a first medical malady domain (e.g., various types of blood diseases) while another request processing pipeline may be trained to answer input requests in another medical malady domain (e.g., various types of cancers). In other cases, for example, the request processing pipelines may be configured to provide different types of cognitive functions or support different types of healthcare applications, such as one request processing pipeline being used for patient diagnosis, another request processing pipeline being configured for medical treatment recommendation, another request processing pipeline being configured for patient monitoring, etc.

Moreover, each request processing pipeline may have their own associated corpus or corpora that they ingest and operate on, e.g., one corpus for blood disease domain documents and another corpus for cancer diagnostics domain related documents in the above examples. In some cases, the request processing pipelines may each operate on the same domain of input questions but may have different configurations, e.g., different annotators or differently trained annotators, such that different analysis and potential answers are generated. The healthcare cognitive system may provide additional logic for routing input questions to the appropriate request processing pipeline, such as based on a determined domain of the input request, combining and evaluating final results generated by the processing performed by multiple request processing pipelines, and other control and interaction logic that facilitates the utilization of multiple request processing pipelines.

As noted above, one type of request processing pipeline with which the mechanisms of the illustrative embodiments may be utilized is a Question Answering (QA) pipeline. The description of example embodiments of the present invention hereafter will utilize a QA pipeline as an example of a request processing pipeline that may be augmented to include mechanisms in accordance with one or more illustrative embodiments. It should be appreciated that while the present invention will be described in the context of the cognitive system implementing one or more QA pipelines that operate on an input question, the illustrative embodiments are not limited to such. Rather, the mechanisms of the illustrative embodiments may operate on requests that are not posed as “questions” but are formatted as requests for the cognitive system to perform cognitive operations on a specified set of input data using the associated corpus or corpora and the specific configuration information used to configure the cognitive system. For example, rather than asking a natural language question of “What diagnosis applies to patient P?” the cognitive system may instead receive a request of “generate diagnosis for patient P,” or the like. It should be appreciated that the mechanisms of the QA system pipeline may operate on requests in a similar manner to that of input natural language questions with minor modifications. In fact, in some cases, a request may be converted to a natural language question for processing by the QA system pipelines if desired for the particular implementation.

As will be discussed in greater detail hereafter, the illustrative embodiments may be integrated in, augment, and extend the functionality of these QA pipeline, or request processing pipeline, mechanisms of a healthcare cognitive system with regard to generating treatment recommendations that are ranked, at least in part, based on the particular patient's ability to afford the treatment. That is, among the factors evaluated by the logic implemented by the QA pipeline is the economic status of the patient in comparison to the costs of treatment, such as may be determined from ingested formularies, pharmaceutical pricing information from pharmaceutical companies, and the like. Additional logic is provided for evaluating the economic status of the patient based on various factors extracted from patient EMR data. Additional logic is also provided for correlating such economic status information with treatment cost information and making a cognitive determination as to how to rank candidate treatments taking into consideration a variety of factors including the patient's economic status relative to the cost of the treatment.

Since the mechanisms of the illustrative embodiments augment the operation of a healthcare cognitive system which may include logic for question processing and answer generation, it is important to first have an understanding of how cognitive systems and question/answer processing in a cognitive system implementing a request/question processing pipeline is performed before describing how the mechanisms of the illustrative embodiments are integrated in and augment such cognitive systems and request processing pipeline, or QA pipeline, mechanisms. It should be appreciated that the mechanisms described in FIGS. 1-4 are only examples and are not intended to state or imply any limitation with regard to the type of cognitive system mechanisms with which the illustrative embodiments are implemented. Many modifications to the example cognitive system shown in FIGS. 1-4 may be implemented in various embodiments of the present invention without departing from the spirit and scope of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

IBM Watson™ is an example of one such cognitive system which can process human readable language and identify inferences between text passages with human-like high accuracy at speeds far faster than human beings and on a larger scale. In general, such cognitive systems are able to perform the following functions:
Navigate the complexities of human language and understanding
Ingest and process vast amounts of structured and unstructured data
Generate and evaluate hypothesis
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situational awareness that mimic human cognition based on experiences
Answer questions based on natural language and specific evidence

In one aspect, cognitive systems provide mechanisms for answering questions posed to these cognitive systems using a Question Answering pipeline or system (QA system) and/or process requests which may or may not be posed as natural language questions. The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to cognitive system which implements the QA pipeline. The QA pipeline then answers the input questions using the content in the corpus of data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e. candidate answer, is inferred by the question. This process is repeated for each of the candidate answers until the QA pipeline identifies candidate answers that surface as being significantly stronger than others and thus, generates a final answer, or ranked set of answers, for the input question.

As mentioned above, QA pipeline mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA pipeline to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA pipeline. Content creators, automated tools, or the like, annotate or otherwise generate metadata for providing information useable by the QA pipeline to identify these question and answer attributes of the content.

Operating on such content, the QA pipeline generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a cognitive system 100 implementing a request processing pipeline 108, which in some embodiments may be a question answering (QA) pipeline, in a computer network 102. For purposes of the present description, it will be assumed that the request processing pipeline 108 is implemented as a QA pipeline that operates on structured and/or unstructured requests in the form of input questions. One example of a question processing operation which may be used in conjunction with the principles described herein is described in U.S. Patent Application Publication No. 2011/0125734, which is herein incorporated by reference in its entirety. The cognitive system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The cognitive system 100 and network 102 enables question processing and answer generation (QA) functionality for one or more cognitive system users via their respective computing devices 110-112. Other embodiments of the cognitive system 100 may be used with components, systems, sub-systems, and/or devices other than those that are depicted herein.

The cognitive system 100 is configured to implement a QA pipeline 108 that receive inputs from various sources. For example, the cognitive system 100 receives input from the network 102, a corpus of electronic documents 106, cognitive system users, and/or other data and other possible sources of input. In one embodiment, some or all of the inputs to the cognitive system 100 are routed through the network 102. The various computing devices 104 on the network 102 include access points for content creators and QA system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus of data 106 for use as part of a corpus of data with the cognitive system 100. The document includes any file, text, article, or source of data for use in the cognitive system 100. QA system users access the cognitive system 100 via a network connection or an Internet connection to the network 102, and input questions to the cognitive system 100 that are answered by the content in the corpus of data 106. In one embodiment, the questions are formed using natural language. The cognitive system 100 parses and interprets the question via a QA pipeline 108, and provides a response to the cognitive system user, e.g., cognitive system user 110, containing one or more answers to the question. In some embodiments, the cognitive system 100 provides a response to users in a ranked list of candidate answers while in other illustrative embodiments, the cognitive system 100 provides a single final answer or a combination of a final answer and ranked listing of other candidate answers.

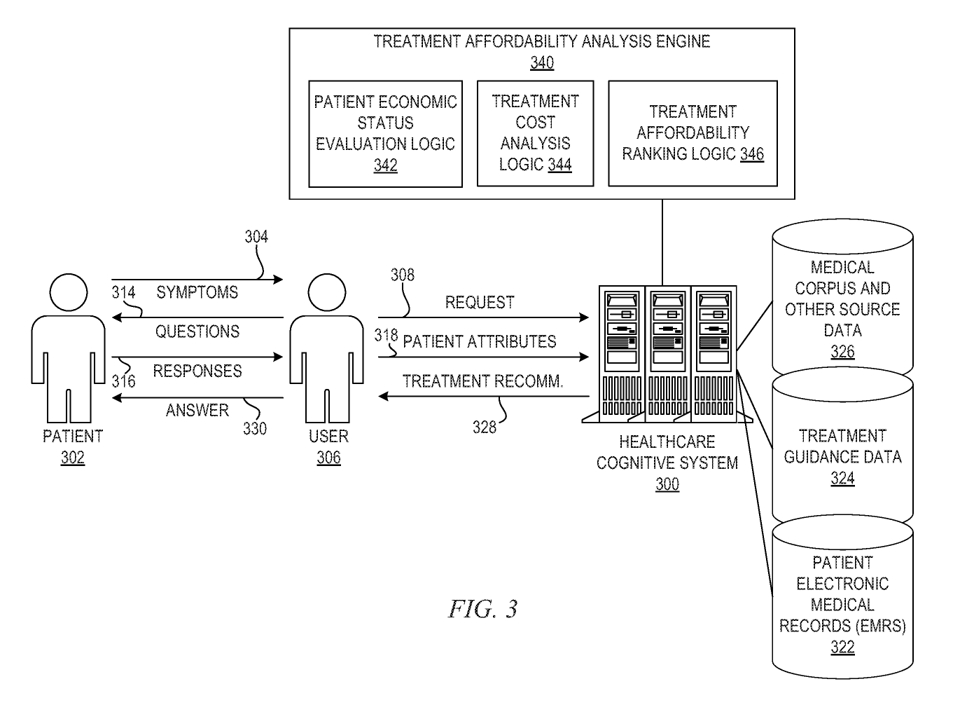

The cognitive system 100 implements the QA pipeline 108 which comprises a plurality of stages for processing an input question and the corpus of data 106. The QA pipeline 108 generates answers for the input question based on the processing of the input question and the corpus of data 106. The QA pipeline 108 will be described in greater detail hereafter with regard to FIG. 3.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a QA pipeline of the IBM Watson™ cognitive system receives an input question which it then parses to extract the major features of the question, which in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA pipeline of the IBM Watson™ cognitive system then performs deep analysis on the language of the input question and the language used in each of the portions of the corpus of data found during the application of the queries using a variety of reasoning algorithms.

The scores obtained from the various reasoning algorithms are then weighted against a statistical model that summarizes a level of confidence that the QA pipeline of the IBM Watson™ cognitive system has regarding the evidence that the potential response, i.e. candidate answer, is inferred by the question. This process is be repeated for each of the candidate answers to generate ranked listing of candidate answers which may then be presented to the user that submitted the input question, or from which a final answer is selected and presented to the user. More information about the QA pipeline of the IBM Watson™ cognitive system may be obtained, for example, from the IBM Corporation website, IBM Redbooks, and the like. For example, information about the QA pipeline of the IBM Watson™ cognitive system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As noted above, while the input to the cognitive system 100 from a client device may be posed in the form of a natural language question, the illustrative embodiments are not limited to such. Rather, the input question may in fact be formatted or structured as any suitable type of request which may be parsed and analyzed using structured and/or unstructured input analysis, including but not limited to the natural language parsing and analysis mechanisms of a cognitive system such as IBM Watson™, to determine the basis upon which to perform cognitive analysis and providing a result of the cognitive analysis. In the case of a healthcare based cognitive system, this analysis may involve processing patient medical records, medical guidance documentation from one or more corpora, and the like, to provide a healthcare oriented cognitive system result.

In the context of the present invention, cognitive system 100 may provide a cognitive functionality for assisting with healthcare based operations. For example, depending upon the particular implementation, the healthcare based operations may comprise patient diagnostics, medical treatment recommendation systems, medical practice management systems, personal patient care plan generation and monitoring, patient electronic medical record (EMR) evaluation for various purposes, such as for identifying patients that are suitable for a medical trial or a particular type of medical treatment, or the like. Thus, the cognitive system 100 may be a healthcare cognitive system 100 that operates in the medical or healthcare type domains and which may process requests for such healthcare operations via the request processing pipeline 108 input as either structured or unstructured requests, natural language input questions, or the like. In one illustrative embodiment, the cognitive system 100 is a healthcare cognitive system in which at least one operation performed by the healthcare cognitive system is a treatment recommendation operation. The treatment recommendation operation analyzes the content of electronic medical records for patients, determines the patient's attributes, the patient's medical condition(s), the previous medical history of the patient, medications being taken by the patient, and other factors relevant to assessing the medical situation of the patient pertinent to treatment of the patient's medical condition(s). It should be appreciated that the patient information may be obtained from a variety of different sources including doctor offices, hospitals, urgent care facilities, medical laboratories, pharmacies, insurance companies (such as medical claims information), and the like. This information may be compiled into one or more electronic medical records (EMRs) associated with the patient via one or more patient identifiers.

The healthcare cognitive system further ingests resource information including, but not limited to, treatment guidance documentation, medical reference texts, pharmaceutical information, medical insurance and other payer information, etc. This resource information may come from a variety of sources including professional organizations, governmental organizations, trusted publications, hospitals, medical laboratories, pharmaceutical companies, and the like. The patient EMR(s) and resource information are collectively depicted as corpus 130 in FIG. 1, upon which the cognitive system 100 operates to perform its healthcare based cognitive operations.

Based on the personal information about the patient present in the patient EMR(s) and the resource information ingested by the healthcare cognitive system 100, as one operation performed by the healthcare cognitive system 100, a treatment recommendation operation is performed to identify candidate treatments for the patient's current medical condition(s). Such analysis may involve determining the most appropriate procedure, surgery, medication, and/or medical equipment to use with the patient to achieve a desired result. This analysis correlates information in the patient's EMR(s) with information about the available treatments to determine which treatments address the patient's current medical condition(s) with the least side effects taking into account co-morbidities, medication interactions, other side effects, effectiveness of the treatment, and any other factors that are pertinent to determining the most appropriate treatment for the patient under current best practices.

Examples of healthcare cognitive systems, also sometimes referred to as clinical decision support systems, that may be implemented as a healthcare cognitive system which is then augmented with the mechanisms of the illustrative embodiments as described hereafter, are described in commonly assigned U.S. Patent Application Publication No. 2014/0303987 entitled “Prediction of an Optimal Medical Treatment”, 2015/0220704 entitled “Clinical Decision Support System over a Bipartite Graph”, and 2016/0117456 entitled “Criteria Conditional Override Based on Patient Information and Supporting Evidence.” It should be appreciated that these are only examples of some healthcare cognitive systems in which aspects of the illustrative embodiments may be implemented and other healthcare cognitive systems may similarly be augmented to include the mechanisms of the illustrative embodiments without departing from the spirit and scope of the present invention.

As shown in FIG. 1, the healthcare cognitive system 100 is further augmented, in accordance with the mechanisms of the illustrative embodiments, to include logic implemented in specialized hardware, software executed on hardware, or any combination of specialized hardware and software executed on hardware, for implementing a treatment affordability analysis engine 120 which operates to determine the economic affordability of various candidate treatments for a patient's medical condition(s) based on an analysis of the patient's economic status in comparison to the treatment costs. This analysis serves to augment other treatment recommendation analysis performed by the healthcare cognitive system 100 by introducing into the treatment recommendation an evaluation of affordability of treatments for the particular patient when determining a relative ranking of candidate treatments being considered by the healthcare cognitive system 100 as potential treatment recommendations to be returned to a healthcare professional for advising the healthcare professional in how to treat the patient's medical condition(s).

As shown in FIG. 1, the treatment affordability analysis engine 120 comprises patient economic status evaluation logic 122, treatment cost analysis logic 124, and treatment affordability ranking logic 126. The patient economic status evaluation logic 122 analyzes various patient demographic and patient medical history information, such as may be obtained from patient EMRs for example, to evaluate a current economic status of the patient. The economic status of the patient is an approximation of a patient's ability to pay for treatments. In the context of medications and formularies used by insurance companies to categorize medications (or pharmaceuticals), the economic status of the patient is an approximation of the tier or tiers of medications in the formularies that the patient is able to afford.

The patient economic status evaluation logic 122 comprises various algorithms and scoring logic to evaluate and weight features of the patient that are relevant to establishing an economic status indicator of the patient. These algorithms and scoring logic may evaluate various features of the patient including, but not limited to, current salary, job title, geographical location of residence which may be correlated to cost of living information, marital information, number of dependents, information regarding dependent and spouse medical costs, and other financial information, e.g., credit report information obtained from credit reporting institutions, mortgage and car payment information, etc. Any information that would provide an indicator of the economic situation of the patient may be included in the analysis performed by the algorithms and scoring logic depending on the desired implementation.

Moreover, these algorithms and scoring logic of the patient economic status evaluation logic 122 may also evaluate the historical treatments undergone by the patient and their corresponding costs to determine a relative measure of the types and costs of treatments this patient has paid for in the past. For example, the patient's EMR data may be searched and analyzed for indicators of prior medications prescribed (as may be indicated by doctor notes, prescription information, and the like, present in the patient EMR) and filled (as may be indicated from pharmacy records or the like), as well as their costs to the patient, medical tier of the corresponding formulary, and the like (as may be obtained from medical insurance or other payer information).

For example, the algorithms and scoring logic may extract from the patient information present in the corpus 130, e.g., in EMRs and other data structures associated with a patient identifier of the patient, the instances of medications prescribed and filled by the patient. This information may then be correlated with cost information available from the patient's payer (insurance company, government organization, pharmaceutical company, etc.) to determine the cost of each medication prescribed and filled. This cost information may then be averaged to determine the average cost of medications the patient has previously paid for. This average cost may then be correlated with the patient's current payer information with regard to formularies and costs of medication to identify a tier of medication that corresponds to the average cost of medication the patient has previously paid for to thereby provide a historical treatment factor into the evaluation of the treatments that the patient can afford. Of course other statistical measures of the historical treatment costs to the patient may be used without departing from the spirit and scope of the present invention, e.g., median treatment costs may be utilized. The historical treatment factor may have an associated weight value that is applied to it to represent its relative importance in determining the economic status of the patient with this weighted historical treatment factor being combined with other weighted factors to generate an overall approximation of the patient's economic status.

The algorithms and scoring logic, may also look at the demographic and other financial information of the patient, and associated various scores and weights applied to this information, to generate additional factors that are combined with the weighted historical treatment factor to evaluate the economic status of the patient. For example, current salary may be categorized into different categories of economic status having associated numerical scores and corresponding weights relative to other demographic and financial information about the patient, e.g., current salary may be more heavily weighted than information about geographical location and cost of living. Similarly, job title information may be cognitively processed and correlated with information about various types of job titles and industries correlated with average income for these particular job titles and industries, and numerical representations of economic status. Again, a weighting value may be associated with this information indicating a relative importance of this information in determining an economic status of the patient relative to other information being evaluated.

In addition, the patient's current status with the payer, such as with regard to payment of premiums, payment of deductibles, and the like, may be taken into consideration as an additional factor when determining the economic status of the patient. For example, if the patient has a payer, but has failed to make the necessary premium payments, then the patient may be considered a non-payer patient meaning that the patient must pay for treatment costs out-of-pocket as the payer is unlikely to cover costs when premium payments have not been received.

The various weighted factors may be combined to generate a final determination of the patient economic status. This determination of the patient economic status is then mapped by the patient economic status evaluation logic 122 to a category of treatments in a particular treatment categorization schema for the patients' particular payer, e.g., insurance company, governmental organization, etc., or a default non-payer based treatment categorization if the patient does not have another payer that they employ to assist with payment of medical expenses, i.e. a non-insured patient. Different payers may have different treatment categorization schema and thus, a different mapping may be utilized depending on the particular patient's current payer, e.g., United Health Insurance Company may have a different formulary from the formulary used by Blue Cross Blue Shield Insurance Company.

The payer information, including formularies or categorizations of treatments, may be obtained by the treatment affordability analysis engine 120 via the ingestion of such information from corpus 130, for example. That is, as part of the ingestion operation of the healthcare cognitive system 100, the treatment recommendation system ingests insurance company guideline information indicating the formulary or formularies used by the insurance company, pharmaceutical company pricing information, government healthcare organization pricing and formulary information, or any other pricing information from payers of healthcare costs. This formulary information lists medications, the amounts paid by the insurance company and patient for this medication, the class or tier of medication, medical conditions addressed by the medication, and the like.

The ingestion of this payer information creates insight data structures (not shown) that may then be applied by the treatment cost analysis logic 124 to the patient economic status information generated by the patient economic status evaluation logic 122 based the evaluation of the patient electronic medical record (EMR) data. This information may also be correlated with the particular candidate treatments that the healthcare cognitive system 100 has identified as candidates for treating the particular patient based on the healthcare cognitive system 100's evaluation of the patient's medical condition, history, and the like as indicated in the patient EMR data. For example, the healthcare cognitive system 100 may process the patient EMR data via the request processing pipeline 108 to generate a plurality of candidate treatments for the patient's medical condition(s) and may score and rank these candidate treatments. As part of the scoring and ranking of these candidate treatments, the treatment affordability analysis engine 120 is implemented to evaluate the candidate treatments and their costs via the patients' payer, or via a non-payer cost evaluation depending on whether the patient has employed a payer or not on their behalf, relative to the economic status of the patient. Each candidate treatment may then be scored according to its correspondence to the economic status of the patient and the payer's agreements with regard to cost and payer/patient payment, e.g., how much of the cost the payer pays and how much of the cost the patient pays (a co-pay or deductible amount for example).

For example, the patient's economic status evaluation may indicate that the patient can and has paid for medications falling within the second tier of the patient's current payer (insurance company) formulary and thus, can afford medications within the second and third tiers of the payer's formulary but is less likely to be able to afford medications in the first tier (or highest tier) of the formulary. The candidate treatments are evaluated by the treatment cost analysis logic 124 against the formulary of the patient's payer to determine where each treatment falls within the formulary, e.g., what tier each treatment is associated with in the formulary. This information is mapped to the evaluation of the patient's economic status to identify which treatments fall within the tiers that the patient's economic status indicates the patient can afford and which do not.

Moreover, the patient's current status regarding deductibles instituted by the patient's payer may be evaluated to determine if the patient has already paid all of their deductibles or not which may affect the cost of the treatment. This information may also be correlated with the recommended treatments and payer information to determine which of the candidate treatments fall under the provisions of the payer's deductible arrangement with the patient and which do not. That is, some treatments fall under a payer's deductible arrangement meaning that the patient is responsible for all or a significant portion of the cost of the treatment up to a maximum deductible amount after which the payer is responsible for all or a significant portion of the cost. In some cases, this means that if the patient has already paid their deductible amount for the particular time period, e.g., calendar year, then subsequent treatments will be at no, or a reduced, cost to the patient. This will modify the particular classes or tiers of treatment that the patient can afford and thus, may be an adjustment to the patient economic status determined by the patient economic status evaluation logic 122 that is applied by the treatment cost analysis logic 124. In some cases, this information may be used as a factor that negates the patient economic status evaluation logic's evaluation of the patient economic status, e.g., if the patient has paid their deductible and thus, is not responsible for any further payment for treatments other than the premium payment to the payer, then the patient can afford any class or tier of treatment since the patient is not responsible for paying for the treatment or is responsible for a relatively small amount of the cost.

Based on the evaluation of the patient's economic status by the patient economic status evaluation logic 122, the treatment cost, mapping of the treatment cost to classes or tiers of treatments associated with the patient's payer information or non-payer cost information, and correlation of the patient's economic status with that of the classes and tiers of treatments, as determined by the treatment cost analysis logic 124, the treatment affordability ranking logic 126 ranks the candidate treatments with regard to the affordability of the candidate treatment to the particular patient. Thus, candidate treatments that fall within the classes or tiers of treatment that the patient's economic status indicates the patient can afford will be given greater weight than candidate treatments that do not. Moreover, rankings within classes or tiers may be made based on relative cost to the patient, payer, or a combination of costs to patient/payer. For example, if the cost of one medication falls under a higher co-pay amount for the patient than another medication, then the smaller co-pay amount medication will be ranked higher than the higher co-pay amount medication so as to attempt to minimize costs to the patient. Other cost based criteria may be used to rank treatments relative to one another within classes or tiers without departing from the spirit and scope of the present invention.

In some cases, patient preferences as indicated in the patient information, such as in patient EMR data obtained from the corpus 130, may be used to perform relative rankings within classes or tiers of treatments. For example, a patient may indicate that they prefer to take name-brand medications over generic medications. In such a case, if both the name-brand and generic medications are candidate treatments and they both fall within the same class or tier of the patient's payer formulary, then based on the patient's preference, the name-brand medication may be ranked higher than the generic medication. Of course this preference information may be weighted and combined with other factors evaluated to perform such ranking of treatments within class/tier without departing from the spirit and scope of the present invention.

The relative rankings of candidate treatments with regard to affordability essentially set forth a relative affordability score value of the candidate treatments which may be communicated to the request processing pipeline 108 of the healthcare cognitive system 100 for use in performing treatment recommendation operations. These relative affordability score values may be combined with other scoring or ranking criteria to generate a ranked listing of candidate treatment recommendations from which one or more final treatment recommendations are selected and presented to a user requesting the treatment recommendation, e.g., a healthcare professional treating the patient. Thus, the illustrative embodiments provide a mechanism for generating treatment recommendations for a patient that not only take into account the ability of the treatment to treat the medical condition(s) of the patient with minimal negative effects, but also take into consideration the patient's ability to afford such treatments.

It should be appreciated that the particular evaluations performed, scoring, and weight values assigned to each portion of information being evaluated may be manually set or machine learned so as to achieve a desired result of the patient economic status evaluation logic 122 and treatment affordability analysis engine 120. For example, through an iterative process using known patient economic status information, the patient economic status evaluation logic 122 may be trained or manually configured such that the results generated match known patient economic status for a plurality of patients. This training logic may then be employed as the patient economic status evaluation logic 122 during runtime operations of the healthcare cognitive system 100 with regard to treatment recommendation generation.

Moreover, it should be appreciated that while FIG. 1 depicts the treatment affordability analysis engine 120 as a separate engine from the cognitive system 100 and pipeline 108, the illustrative embodiments are not limited to such an arrangement. In fact, in some illustrative embodiments, the treatment affordability analysis engine 120 is implemented as logic within the cognitive system 100. In some illustrative embodiments, the treatment affordability analysis engine 120 may be implemented as logic in one or more of the logic stages of the request processing pipeline 108. For example, the treatment affordability analysis engine 120 may be implemented as part of logic in a stage of the request processing pipeline 108 responsible for scoring and ranking candidate treatment recommendations. Any arrangement of the treatment affordability analysis engine 120 as part of, or separate from, the cognitive system 100 and/or request processing pipeline 108 is intended to be within the spirit and scope of the illustrative embodiments.

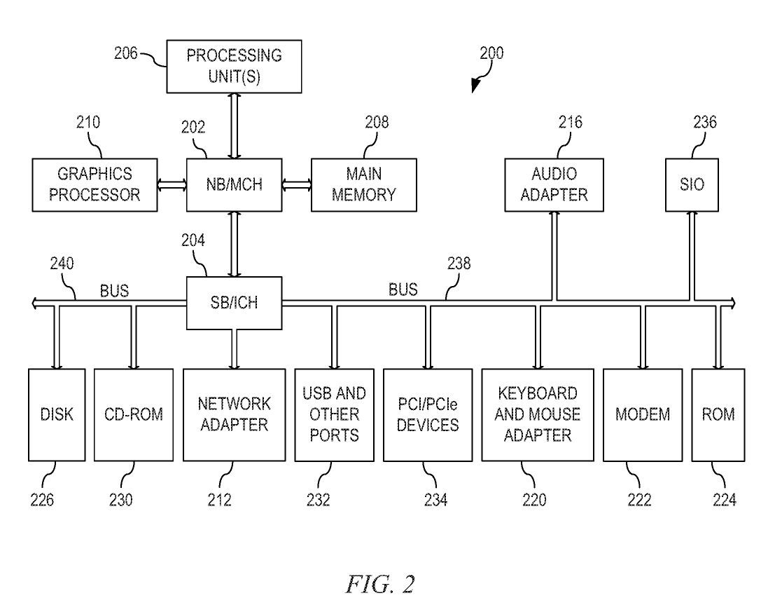

As noted above, the mechanisms of the illustrative embodiments are rooted in the computer technology arts and are implemented using logic present in such computing or data processing systems. These computing or data processing systems are specifically configured, either through hardware, software, or a combination of hardware and software, to implement the various operations described above. As such, FIG. 2 is provided as an example of one type of data processing system in which aspects of the present invention may be implemented. Many other types of data processing systems may be likewise configured to specifically implement the mechanisms of the illustrative embodiments.

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a cognitive system 100 and QA system pipeline 108 augmented to include the additional mechanisms of the illustrative embodiments described hereafter.

In the depicted example, data processing system 200 employs a hub architecture including North Bridge and Memory Controller Hub (NB/MCH) 202 and South Bridge and Input/Output (I/O) Controller Hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 10®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive) (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 is an example diagram illustrating an interaction of elements of a healthcare cognitive system in accordance with one illustrative embodiment. The example diagram of FIG. 3 depicts an implementation of a healthcare cognitive system 300 that is configured to provide medical treatment recommendations for patients. However, it should be appreciated that this is only an example implementation and other healthcare operations may be implemented in other embodiments of the healthcare cognitive system 300, in addition to or alternative to treatment recommendation generation, without departing from the spirit and scope of the present invention. Essentially, in the context of the illustrative embodiments, the healthcare cognitive system 300 may implement any healthcare based cognitive operation where treatment affordability is of concern in the evaluation and performance of the healthcare based cognitive operation. Treatment recommendation is used as one example of such a healthcare based cognitive operation.

Moreover, it should be appreciated that while FIG. 3 depicts the patient 302 and user 306 as human figures, the interactions with and between these entities may be performed using computing devices, medical equipment, and/or the like, such that entities 302 and 306 may in fact be computing devices, e.g., client computing devices. For example, the interactions 304, 314, 316, and 330 between the patient 302 and the user 306 may be performed orally, e.g., a doctor interviewing a patient, and may involve the use of one or more medical instruments, monitoring devices, or the like, to collect information that may be input to the healthcare cognitive system 300 as patient attributes 318. Interactions between the user 306 and the healthcare cognitive system 300 will be electronic via a user computing device (not shown), such as a client computing device 110 or 112 in FIG. 1, communicating with the healthcare cognitive system 300 via one or more data communication links and potentially one or more data networks.

As shown in FIG. 3, in accordance with one illustrative embodiment, a patient 302 presents symptoms 304 of a medical malady or condition to a user 306, such as a healthcare practitioner, technician, or the like. The user 306 may interact with the patient 302 via a question 314 and response 316 exchange where the user gathers more information about the patient 302, the symptoms 304, and the medical malady or condition of the patient 302. It should be appreciated that the questions/responses may in fact also represent the user 306 gathering information from the patient 302 using various medical equipment, e.g., blood pressure monitors, thermometers, wearable health and activity monitoring devices associated with the patient such as a FitBit™, a wearable heart monitor, or any other medical equipment that may monitor one or more medical characteristics of the patient 302. In some cases such medical equipment may be medical equipment typically used in hospitals or medical centers to monitor vital signs and medical conditions of patients that are present in hospital beds for observation or medical treatment.

In response, the user 302 submits a request 308 to the healthcare cognitive system 300, such as via a user interface on a client computing device that is configured to allow users to submit requests to the healthcare cognitive system 300 in a format that the healthcare cognitive system 300 can parse and process. The request 308 may include, or be accompanied with, information identifying patient attributes 318. These patient attributes 318 may include, for example, an identifier of the patient 302 from which patient EMRs 322 for the patient may be retrieved, demographic information about the patient, the symptoms 304, and other pertinent information obtained from the responses 316 to the questions 314 or information obtained from medical equipment used to monitor or gather data about the condition of the patient 302. Any information about the patient 302 that may be relevant to a cognitive evaluation of the patient by the healthcare cognitive system 300 may be included in the request 308 and/or patient attributes 318.

The healthcare cognitive system 300 provides a cognitive system that is specifically configured to perform an implementation specific healthcare oriented cognitive operation. In the depicted example, this healthcare oriented cognitive operation is directed to providing a treatment recommendation 328 to the user 306 to assist the user 306 in treating the patient 302 based on their reported symptoms 304 and other information gathered about the patient 302 via the question 314 and response 316 process and/or medical equipment monitoring/data gathering. The healthcare cognitive system 300 operates on the request 308 and patient attributes 318 utilizing information gathered from the medical corpus and other source data 326, treatment guidance data 324, and the patient EMRs 322 associated with the patient 302 to generate one or more treatment recommendation 328. The treatment recommendations 328 may be presented in a ranked ordering with associated supporting evidence, obtained from the patient attributes 318 and data sources 322-326, indicating the reasoning as to why the treatment recommendation 328 is being provided and why it is ranked in the manner that it is ranked.

For example, based on the request 308 and the patient attributes 318, the healthcare cognitive system 300 may operate on the request, such as by using a QA pipeline type processing as described herein, to parse the request 308 and patient attributes 318 to determine what is being requested and the criteria upon which the request is to be generated as identified by the patient attributes 318, and may perform various operations for generating queries that are sent to the data sources 322-326 to retrieve data, generate candidate treatment recommendations (or answers to the input question), and score these candidate treatment recommendations based on supporting evidence found in the data sources 322-326. In the depicted example, the patient EMRs 322 is a patient information repository that collects patient data from a variety of sources, e.g., hospitals, laboratories, physicians' offices, health insurance companies, pharmacies, etc. The patient EMRs 322 store various information about individual patients, such as patient 302, in a manner (structured, unstructured, or a mix of structured and unstructured formats) that the information may be retrieved and processed by the healthcare cognitive system 300. This patient information may comprise various demographic information about patients, personal contact information about patients, employment information, health insurance information, laboratory reports, physician reports from office visits, hospital charts, historical information regarding previous diagnoses, symptoms, treatments, prescription information, etc. Based on an identifier of the patient 302, the patient's corresponding EMRs 322 from this patient repository may be retrieved by the healthcare cognitive system 300 and searched/processed to generate treatment recommendations 328.

The treatment guidance data 324 provides a knowledge base of medical knowledge that is used to identify potential treatments for a patient based on the patient's attributes 318 and historical information presented in the patient's EMRs 322. This treatment guidance data 324 may be obtained from official treatment guidelines and policies issued by medical authorities, e.g., the American Medical Association, may be obtained from widely accepted physician medical and reference texts, e.g., the Physician's Desk Reference, insurance company guidelines, or the like. The treatment guidance data 324 may be provided in any suitable form that may be ingested by the healthcare cognitive system 300 including both structured and unstructured formats.

In some cases, such treatment guidance data 324 may be provided in the form of rules that indicate the criteria required to be present, and/or required not to be present, for the corresponding treatment to be applicable to a particular patient for treating a particular symptom or medical malady/condition. For example, the treatment guidance data 324 may comprise a treatment recommendation rule that indicates that for a treatment of Decitabine, strict criteria for the use of such a treatment is that the patient 302 is less than or equal to 60 years of age, has acute myeloid leukemia (AML), and no evidence of cardiac disease. Thus, for a patient 302 that is 59 years of age, has AML, and does not have any evidence in their patient attributes 318 or patient EMRs indicating evidence of cardiac disease, the following conditions of the treatment rule exist:

Age<=60 years=59 (MET);

Patient has AML=AML (MET); and

Cardiac Disease=false (MET)

Since all of the criteria of the treatment rule are met by the specific information about this patient 302, then the treatment of Decitabine is a candidate treatment for consideration for this patient 302. However, if the patient had been 69 years old, the first criterion would not have been met and the Decitabine treatment would not be a candidate treatment for consideration for this patient 302. Various potential treatment recommendations may be evaluated by the healthcare cognitive system 300 based on ingested treatment guidance data 324 to identify subsets of candidate treatments for further consideration by the healthcare cognitive system 300 by scoring such candidate treatments based on evidential data obtained from the patient EMRs 322 and medical corpus and other source data 326.

For example, data mining processes may be employed to mine the data in sources 322 and 326 to identify evidential data supporting and/or refuting the applicability of the candidate treatments to the particular patient 302 as characterized by the patient's patient attributes 318 and EMRs 322. For example, for each of the criteria of the treatment rule, the results of the data mining provides a set of evidence that supports giving the treatment in the cases where the criterion is “MET” and in cases where the criterion is “NOT MET.” The healthcare cognitive system 300 processes the evidence in accordance with various cognitive logic algorithms to generate a confidence score for each candidate treatment recommendation indicating a confidence that the corresponding candidate treatment recommendation is valid for the patient 302. The candidate treatment recommendations may then be ranked according to their confidence scores and presented to the user 306 as a ranked listing of treatment recommendations 328. In some cases, only a highest ranked, or final answer, is returned as the treatment recommendation 328. The treatment recommendation 328 may be presented to the user 306 in a manner that the underlying evidence evaluated by the healthcare cognitive system 300 may be accessible, such as via a drilldown interface, so that the user 306 may identify the reasons why the treatment recommendation 328 is being provided by the healthcare cognitive system 300.

In accordance with the illustrative embodiments herein, the healthcare cognitive system 300 is augmented to include a treatment affordability analysis engine 340, either separate from or integrated in the healthcare cognitive system 300, which evaluates candidate treatments with regard to the particular patient's ability to afford the candidate treatments as detailed above with regard to FIG. 1. Thus, when generating a treatment recommendation 328, the healthcare cognitive system 300 further factors into the evaluation the patient's economic status, the costs and classes/tiers of the candidate treatments, the patient's current status with the patient's payer, and other cost based factors to evaluate the patient's ability to pay for or afford the candidate treatments. Such affordability scores or factors are combined with the other scores, weights, and factors used by the healthcare cognitive system 300 when evaluating candidate treatments for the patient 302 and selecting a treatment recommendation 328 to provide to the user 306.

While FIG. 3 is depicted with an interaction between the patient 302 and a user 306, which may be a healthcare professional or practitioner such as a physician, nurse, physician's assistant, lab technician, or any other healthcare worker, for example, the illustrative embodiments do not require such. Rather, the patient 302 may interact directly with the healthcare cognitive system 300 without having to go through an interaction with the user 306 and the user 306 may interact with the healthcare cognitive system 300 without having to interact with the patient 302. For example, in the first case, the patient 302 may be requesting 308 treatment recommendations 328 from the healthcare cognitive system 300 directly based on the symptoms 304 provided by the patient 302 to the healthcare cognitive system 300. Moreover, the healthcare cognitive system 300 may actually have logic for automatically posing questions 314 to the patient 302 and receiving responses 316 from the patient 302 to assist with data collection for generating treatment recommendations 328. In the latter case, the user 306 may operate based on only information previously gathered and present in the patient EMR 322 by sending a request 308 along with patient attributes 318 and obtaining treatment recommendations in response from the healthcare cognitive system 300. Thus, the depiction in FIG. 3 is only an example and should not be interpreted as requiring the particular interactions depicted when many modifications may be made without departing from the spirit and scope of the present invention. It should be appreciated, however, that at no time should the treatment itself be administered to the patient 302 without prior approval of the healthcare professional treating the patient, i.e. final determinations as to treatments given to a patient will always fall on the healthcare professional with the mechanisms of the illustrative embodiments serving only as an advisory tool for the healthcare professional (user 306) and/or patient 302.

As mentioned above, the healthcare cognitive system 300 may include a request processing pipeline, such as request processing pipeline 108 in FIG. 1, which may be implemented, in some illustrative embodiments, as a Question Answering (QA) pipeline. The QA pipeline may receive an input question, such as “what is the appropriate treatment for patient P?”, or a request, such as “diagnose and provide a treatment recommendation for patient P.”

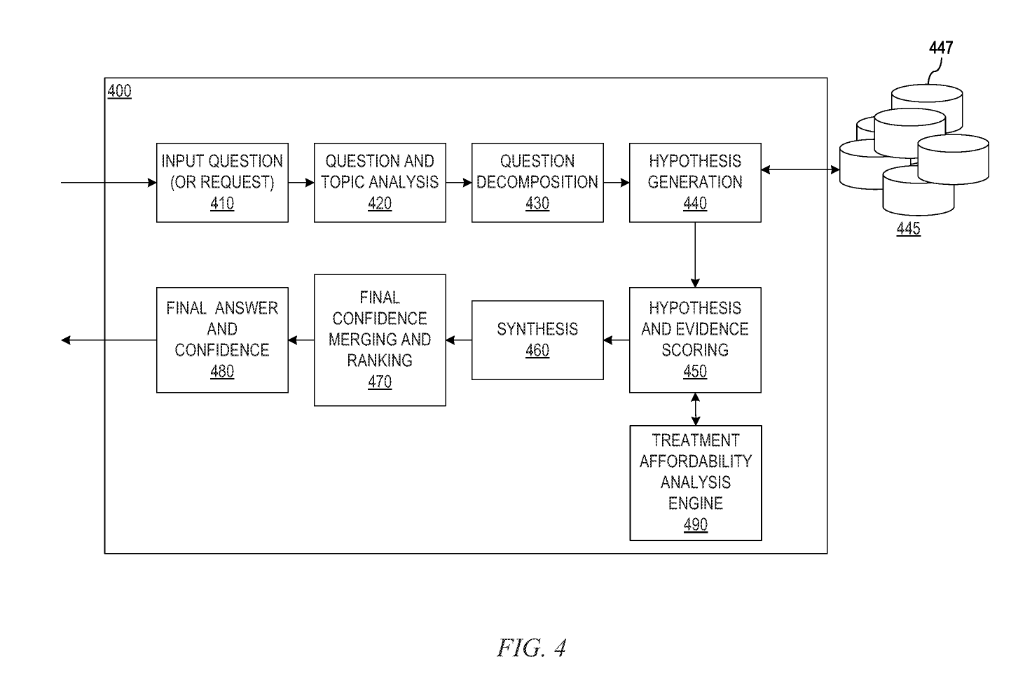

FIG. 4 illustrates a QA pipeline of a healthcare cognitive system, such as healthcare cognitive system 300 in FIG. 3, or an implementation of cognitive system 100 in FIG. 1, for processing an input question in accordance with one illustrative embodiment. It should be appreciated that the stages of the QA pipeline shown in FIG. 4 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA pipeline of FIG. 4 is augmented, for example, in one or more of the stages to implement the improved mechanism of the illustrative embodiments described hereafter, additional stages may be provided to implement the improved mechanism, or separate logic from the pipeline 400 may be provided for interfacing with the pipeline 400 and implementing the improved functionality and operations of the illustrative embodiments.

As shown in FIG. 4, the QA pipeline 400 comprises a plurality of stages 410-480 through which the cognitive system operates to analyze an input question and generate a final response. In an initial question input stage 410, the QA pipeline 400 receives an input question that is presented in a natural language format. That is, a user inputs, via a user interface, an input question for which the user wishes to obtain an answer, e.g., “What medical treatments for diabetes are applicable to a 60 year old patient with cardiac disease?” In response to receiving the input question, the next stage of the QA pipeline 400, i.e. the question and topic analysis stage 420, parses the input question using natural language processing (NLP) techniques to extract major features from the input question, and classify the major features according to types, e.g., names, dates, or any of a plethora of other defined topics. For example, in a question of the type “Who were Washington's closest advisors?”, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic. Similarly, in the previous question “medical treatments” may be associated with pharmaceuticals, medical procedures, holistic treatments, or the like, “diabetes” identifies a particular medical condition, “60 years old” indicates an age of the patient, and “cardiac disease” indicates an existing medical condition of the patient.

In addition, the extracted major features include key words and phrases, classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “ drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 4, the identified major features are then used during the question decomposition stage 430 to decompose the question into one or more queries that are applied to the corpora of data/information 445 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 445. That is, these various sources themselves, different collections of sources, and the like, represent a different corpus 447 within the corpora 445. There may be different corpora 447 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 447 within the corpora 445.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 440 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 440, to generate hypotheses for answering the input question. These hypotheses are also referred to herein as “candidate answers” for the input question. For any input question, at this stage 440, there may be hundreds of hypotheses or candidate answers generated that may need to be evaluated.

The QA pipeline 400, in stage 450, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 460, the large number of scores generated by the various reasoning algorithms are synthesized into confidence scores or confidence measures for the various hypotheses. This process involves applying weights to the various scores, where the weights have been determined through training of the statistical model employed by the QA pipeline 400 and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA pipeline 400 that identifies a manner by which these scores may be combined to generate a confidence score or measure for the individual hypotheses or candidate answers. This confidence score or measure summarizes the level of confidence that the QA pipeline 400 has about the evidence that the candidate answer is inferred by the input question, i.e. that the candidate answer is the correct answer for the input question.

The resulting confidence scores or measures are processed by a final confidence merging and ranking stage 470 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 480, a final answer and confidence score, or final set of candidate answers and confidence scores, are generated and output to the submitter of the original input question via a graphical user interface or other mechanism for outputting information.

As shown in FIG. 4, in accordance with one illustrative embodiment, the hypothesis and evidence scoring stage 450 logic is augmented to include treatment affordability analysis engine 490 which operates to evaluate the hypotheses, i.e. the candidate treatments, with regard to the patient's ability to afford the candidate treatments, such as in the manner described above with regard to FIG. 1. While the treatment affordability analysis engine 490 is shown as separate logic in the pipeline 400, it may in fact be integrated into the hypothesis and evidence scoring stage 450 logic as additional scoring logic applied to the features of the patient information, e.g., patient demographic and EMR data, features of the patient's payer information, and the features of the candidate treatments, as may be obtained from the corpus or corpora 445, 447. The resulting final answer and confidence scores generated at stage 480 may thus, be selected based on a relative ranking of candidate treatment recommendations that take into consideration the patient's ability to afford the various candidate treatments with such affordability factors and weights influencing the confidence scores associated with the candidate treatments.

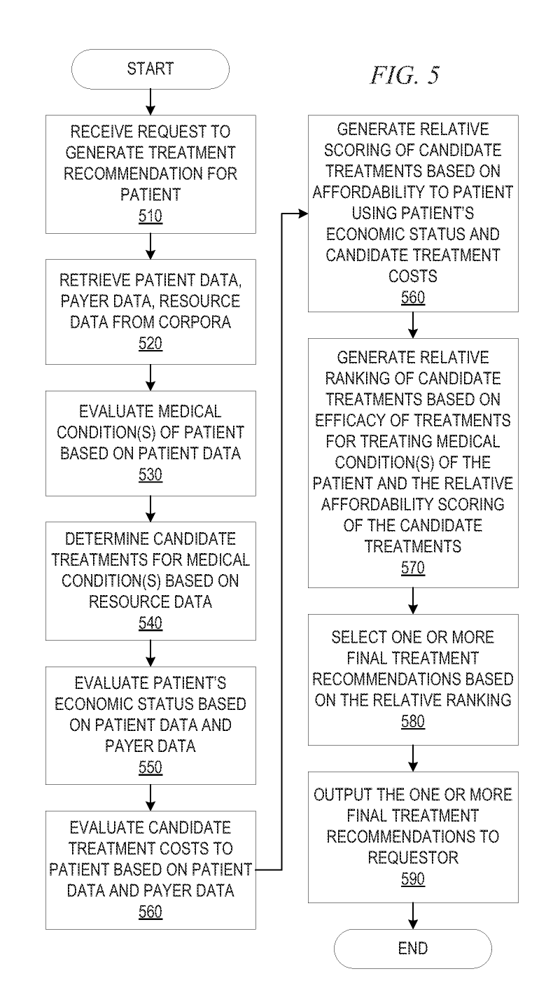

FIG. 5 is a flowchart outlining an example operation of a healthcare cognitive system with regard to a treatment recommendation operation that evaluates the affordability of treatments for a patient in accordance with one illustrative embodiment. As shown in FIG. 5, the operation starts with the receipt of a request, from a requestor who may be a human user via a computing device or an automated system, for a treatment recommendation for a designated patient (step 510). In response to receiving the request, the required information for satisfying the request is ingested, if not already ingested, at least by retrieving the corresponding patient data for the designated patient (e.g., patient EMR data, user or patient entered patient symptoms, diagnoses, attributes, etc.), payer data for the patient's payer (e.g., insurance company data, government organization data, etc.), and resource data (e.g., medical treatment guidelines, etc.) from one or more corpora (step 520). The patient data is evaluated using the resource data to evaluate and identify the particular medical condition(s) associated with the patient (step 530). Candidate treatments are determined for the identified medical condition(s) based on the application of the resource data to the patient data and using the cognitive abilities of the healthcare cognitive system (step 540).

In accordance with the illustrative embodiments, the patient's economic status is determined based on a cognitive analysis of the patient data and payer data, such as in the manner previously described with regard to one or more of the illustrative embodiments discussed with reference to FIGS. 1-4 above (step 550). The candidate treatment costs are evaluated based on the patient data and payer data, again in a manner such as previously described with regard to one or more of the illustrative embodiments discussed with reference to FIGS. 1-4 above (step 560). A relative scoring of candidate treatments based on affordability to the patient is generated using the patient's economic status and candidate treatment costs in accordance with one or more of the previously described illustrative embodiments (step 570).

Thereafter, a relative ranking of candidate treatments is generated based on the efficacy of the candidate treatments for treating the medical condition(s) of the patient and the relative affordability scoring of the candidate treatments (step 570). One or more final treatment recommendations are selected from the ranked listing of candidate treatments (step 580) and the selected final treatment recommendation(s) are output to the requestor (step 590). The operation then terminates.

Thus, the illustrative embodiments provide mechanisms that improve the operation of healthcare based cognitive systems, decision support systems, and/or treatment recommendation systems by augmenting their evaluations of patient treatments to take into consideration the patient's ability to afford the treatments. Thus, not only do these systems evaluate candidate treatments based on their ability to treat the patient's particular medical condition(s) with minimal negative effects, but the mechanisms of the illustrative embodiments further improve these evaluations by determining the patient's economic status relative to the cost of the candidate treatments for the particular patient, to determine which candidate treatments are most appropriate for recommending for this particular patient. Hence, the accuracy of treatment recommendation is improved while improving the likelihood that the patient will follow the recommended treatment by recommending treatments that the patient is able to afford.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions executed by the at least one processor to cause the at least one processor to implement a cognitive medical treatment recommendation system, the method comprising:
ingesting, by the cognitive medical treatment recommendation system, medical treatment information data structure for a medical payment provider, wherein the medical treatment information data structure provides treatment information including costs to patients for one or more medical treatments;
generating, by the cognitive medical treatment recommendation system, a set of insight data structures based on the ingested medical treatment information for the at least one medical payment provider;
processing, by the cognitive medical treatment recommendation system, personal information about a patient to determine an economic status of the patient;
processing, by the cognitive medical treatment recommendation system, an electronic medical record for the patient identifying a medical condition of the patient to generate a plurality of candidate treatment options for treating the medical condition of the patient;
selecting, by the cognitive medical treatment recommendation system, a treatment option from the plurality of candidate treatment options based on the set of insight data structures and the economic status of the patient; and
outputting, by the cognitive medical treatment system, the selected treatment option for use in treating the medical condition of the patient.

2. The method of claim 1, wherein the medical treatment information data structure is a formulary data structure specifying pharmaceuticals organized according to categories associated with cost and payment criteria.

3. The method of claim 1, wherein processing the personal information about the patient to determine an economic status of the patient comprises determining the economic status of the patient based on one or more patient economic factors indicative of at least one of an income of the patient, a geographical location of the patient, previous medications prescribed to and obtained by the patient, marital status of the patient, or a number of dependents of the patient.

4. The method of claim 3, wherein processing the personal information about the patient to determine an economic status of the patient comprises performing a weighted calculation of a plurality of the patient economic factors, wherein at least two of the patient economic factors have different weights.

5. The method of claim 1, wherein the medical treatment information data structure comprises a plurality of tiers of medical treatments wherein each tier is associated with a different level of cost of medical treatments, and wherein selecting a medical treatment from the plurality of candidate treatments comprises selecting a medical treatment that is classified into a tier specified in the medical treatment information data structure which corresponds to the determined economic status of the patient.

6. The method of claim 1, wherein selecting a medical treatment comprises:
weighting scores associated with each candidate medical treatment in a plurality of candidate medical treatments based on whether or not the candidate medical treatment falls within a tier of the medical treatment information data structure corresponding to the determined economic status of the patient; and
selecting a candidate medical treatment based on a ranking of scores associated with each of the candidate medical treatments in the plurality of candidate medical treatments.

7. The method of claim 1, wherein selecting the medical treatment based on the set of insight data structures and the economic status of the patient comprises:
analyzing effectiveness information for each candidate medical treatment in a plurality of candidate medical treatments, wherein the effectiveness information indicates a level of effectiveness of a corresponding candidate medical treatment in treating the medical condition; and
selecting the medical treatment based on a ranking of each candidate medical treatment relative to other candidate medical treatments in the plurality of candidate medical treatments, wherein the ranking of a candidate medical treatment is based on an effectiveness of the candidate medical treatment and a correspondence of cost of the candidate medical treatment with the economic status of the patient.

8. The method of claim 1, wherein the medical treatment comprises at least one of a surgery, medical procedure, medical equipment, dental procedure, dental surgery, dental equipment, or pharmaceutical.

9. The method of claim 1, wherein processing personal information about a patient to determine an economic status of the patient comprises identifying one or more pharmaceuticals for which a previous prescription was filled by the patient, and correlating the one or more pharmaceuticals with costs to the patient of the one or more pharmaceuticals.

10. The method of claim 1, wherein processing personal information about a patient to determine an economic status of the patient comprises determining a current payment status of the patient with regard to payments required by the medical payment provider.

11. A computer program product comprising a computer readable storage medium having a computer readable program stored therein, wherein the computer readable program, when executed on a computing device, causes the computing device to:
ingest a medical treatment information data structure from a medical payment provider, wherein the medical treatment information data structure includes costs to patients for one or more medical treatments, and wherein ingesting the medical treatment information data structure generates a set of insight data structures representing one or more candidate medical treatments;
process personal information about a patient to determine an economic status of the patient;
process an electronic medical record for the patient identifying a medical condition of the patient;
select a medical treatment for treating the medical condition of the patient based on the set of insight data structures and the determined economic status of the patient; and
output a medical treatment recommendation, corresponding to the selected medical treatment, for use in treating the medical condition of the patient.

12. The computer program product of claim 11, wherein the medical treatment information data structure is a formulary data structure specifying pharmaceuticals organized according to categories associated with cost and payment criteria.

13. The computer program product of claim 11, wherein the computer readable program further causes the computing device to process the personal information about the patient to determine an economic status of the patient at least by determining the economic status of the patient based on one or more patient economic factors indicative of at least one of an income of the patient, a geographical location of the patient, previous medications prescribed to and obtained by the patient, marital status of the patient, or a number of dependents of the patient.

14. The computer program product of claim 13, wherein the computer readable program further causes the computing device to process the personal information about the patient to determine an economic status of the patient at least by performing a weighted calculation of a plurality of the patient economic factors, wherein at least two of the patient economic factors have different weights.

15. The computer program product of claim 11, wherein the medical treatment information data structure comprises a plurality of tiers of medical treatments wherein each tier is associated with a different level of cost of medical treatments, and wherein selecting a medical treatment from the plurality of candidate treatments comprises selecting a medical treatment that is classified into a tier specified in the medical treatment information data structure which corresponds to the determined economic status of the patient.

16. The computer program product of claim 11, wherein the computer readable program further causes the computing device to select a medical treatment at least by:
weighting scores associated with each candidate medical treatment in a plurality of candidate medical treatments based on whether or not the candidate medical treatment falls within a tier of the medical treatment information data structure corresponding to the determined economic status of the patient; and
selecting a candidate medical treatment based on a ranking of scores associated with each of the candidate medical treatments in the plurality of candidate medical treatments.

17. The computer program product of claim 11, wherein the computer readable program further causes the computing device to select the medical treatment based on the set of insight data structures and the economic status of the patient at least by:
analyzing effectiveness information for each candidate medical treatment in a plurality of candidate medical treatments, wherein the effectiveness information indicates a level of effectiveness of a corresponding candidate medical treatment in treating the medical condition; and
selecting the medical treatment based on a ranking of each candidate medical treatment relative to other candidate medical treatments in the plurality of candidate medical treatments, wherein the ranking of a candidate medical treatment is based on an effectiveness of the candidate medical treatment and a correspondence of cost of the candidate medical treatment with the economic status of the patient.

18. The computer program product of claim 11, wherein the medical treatment comprises at least one of a surgery, medical procedure, medical equipment, dental procedure, dental surgery, dental equipment, or pharmaceutical.

19. The computer program product of claim 11, wherein the computer readable program further causes the computing device to process personal information about a patient to determine an economic status of the patient at least by identifying one or more pharmaceuticals for which a previous prescription was filled by the patient, and correlating the one or more pharmaceuticals with costs to the patient of the one or more pharmaceuticals.

20. An apparatus comprising:
a processor; and
a memory coupled to the processor, wherein the memory comprises instructions which, when executed by the processor, cause the processor to:
ingest a medical treatment information data structure from a medical payment provider, wherein the medical treatment information data structure includes costs to patients for one or more medical treatments, and wherein ingesting the medical treatment information data structure generates a set of insight data structures representing one or more candidate medical treatments;
process personal information about a patient to determine an economic status of the patient;
process an electronic medical record for the patient identifying a medical condition of the patient;
select a medical treatment for treating the medical condition of the patient based on the set of insight data structures and the determined economic status of the patient; and
output a medical treatment recommendation, corresponding to the selected medical treatment, for use in treating the medical condition of the patient.
